(19) United States
(12) Patent Application Publication
(10) Pub. No.: US 2016/0363473 A1
(43) Pub. Date: Dec. 15, 2016

(54) SYSTEM FOR INSPECTING UREA QUALITY AND METHOD FOR THE SAME

(71) Applicants: HYUNDAI MOTOR COMPANY, Seoul (KR); KIA MOTORS CORPORATION, Seoul (KR)

(72) Inventor: Jang Hyun JUNG, Suwon-si (KR)

(21) Appl. No.: 14/958,504

(22) Filed: Dec. 3, 2015

(30) Foreign Application Priority Data
Jun. 11, 2015 (KR) 10-2015-0082419

(51) Int. Cl. G01F 23/296; G01F 23/00

(52) U.S. Cl. CPC G01F 23/2962; G01F 23/0061

(57) ABSTRACT

A system for inspecting urea quality includes a lower ultrasonic sensor, which is in contact with a urea liquid and installed at a bottom portion of a urea tank inside the urea tank, outputting an ultrasonic wave toward a top portion and receiving the ultrasonic wave reflected on a urea liquid surface; an upper ultrasonic sensor, which is in contact with the air and installed at the top portion of the urea tank inside the urea tank, outputting the ultrasonic wave toward the bottom portion and receiving the ultrasonic wave reflected on the liquid surface of the urea; and a controller, which is electrically connected with the upper ultrasonic sensor and the lower ultrasonic sensor, configured to calculate distances from each ultrasonic sensor to the urea liquid surface by the ultrasonic wave, and configured to determine whether the urea quality is abnormal from the calculated distances.

### CROSS-REFERENCE TO RELATED APPLICATION

This application claims under 35 U.S.C. §119(a) the benefit of priority to Korean Patent Application No. 10-2015-0082419 filed on Jun. 11, 2015, the entire content of which is incorporated herein by reference.

### TECHNICAL FIELD

The present disclosure relates to a system and a method for inspecting urea quality. More particularly, the present disclosure relates to a system and a method capable of inspecting quality of urea injected into a urea tank by using a simple configuration in a vehicle on which an selective catalytic reduction (SRC) system and a urea supply apparatus are mounted.

### BACKGROUND

As environmental pollution has been one of major issues, exhaust gas regulations for vehicles using fossil fuel have been gradually restricted.

In particular, exhaust gas of a diesel vehicle such as a bus or a truck includes a great quantity of nitrogen oxide (NOx) and according to the recent exhaust gas regulation, an emission standard of nitrogen oxide has been more restricted.

Accordingly, a method has been developed to reduce nitrogen oxide included in exhaust gas of a diesel engine by applying a selective catalytic reduction (SCR) system to a vehicle to cope with the emission standard.

The SCR system which can effectively reduce NOx by supplying reductant to SCR catalyst reduces NOx by supplying a reductant such as ammonia to the exhaust gas unlike exhaust gas recirculation that reduces NOx by lowering a combustion temperature by recirculating the exhaust gas to a combustion chamber.

In general, in the diesel vehicle mounted with SCR catalyst, urea is injected to an exhaust pipe by using an injector. When the injected urea is dissolved into ammonia by heat of the exhaust gas, NOx in the exhaust gas is reduced by a reduction process in which the dissolved ammonia reacts with NOx in the exhaust gas in the SCR catalyst to be dissolved into nitrogen (N₂) and vapor (H₂O).

The urea is used, which is approximately 4 to 6% of a general fuel usage in order to reduce nitrogen oxide as described above and urea needs to be periodically filled as filling fuel in the vehicle. A urea tank storing urea, a filler neck for injecting urea in the urea tank and the like are provided together with a fuel tank in the diesel vehicle adopting the SCR system.

The SCR system has been primarily used in a large vehicle such as the truck, or the like at present, but the SCR system can be also used for a small vehicle and a medium vehicle. Since the urea needs to be filled in the urea tank, an injection frequency of the urea has been also increased and a scheme of injecting the urea by using an injection gun at a gas station, a scheme in which a driver directly injects the urea and the like can be applied.

FIG. 1 is a diagram illustrating a urea supplying apparatus for a vehicle having an SCR system. The urea supplying apparatus includes a urea tank 10 storing urea, a pump 11 pumping the urea stored in the urea tank 10 and pressure-feeding the pumped urea through a urea line 12, and an injector 13 injecting the urea pressure-fed by the pump 11 and injecting the pressure-fed urea to an exhaust pipe 1.

Reference numeral 2 represents an SCR catalyst, reference numeral 3 represents a temperature sensor, and reference numeral 4 represents a NOx sensor.

In addition to the components, although not illustrated in FIG. 1, components may be added, which include a filler neck injecting the urea into the urea tank 10, a level sensor detecting a level of urea in the urea tank, a temperature sensor detecting the temperature of the urea in the urea tank, a urea heating device heating the urea in the urea tank, a urea filter removing foreign substances in the urea pressure-fed to an injector from the urea tank, and a control unit controlling operations of the pump, the urea heating device, the injector, and the like for controlling supply and injection of the urea while receiving signals of the level sensor and the temperature sensor.

FIG. 2 is a perspective view illustrating the urea tank and a pump module of the urea supplying apparatus, and in general, the urea supplying apparatus is installed in the form of a pump module 11a in which the pump 11, the urea heating device 14, a urea filter (not illustrated), a level sensor (not illustrated), and a temperature sensor (not illustrated) are modularized.

FIG. 3 is a diagram for describing a measurement principle of a level sensor detecting the level of the urea in the urea tank. An ultrasonic sensor may be used as the level sensor for detecting the level of the urea.

FIG. 3 schematically illustrates, by the arrow, movement of an ultrasonic wave which is output by the ultrasonic sensor, and thereafter, reflected on a surface of the urea and returns.

As illustrated in FIG. 3, an ultrasonic sensor that transmits/receives the ultrasonic wave is installed on a lower end of the urea tank 10 and the ultrasonic wave is output upward from the ultrasonic sensor at the lower end. Here, a liquid level is measured by measuring a time during which the ultrasonic wave transmitted from the ultrasonic sensor is reflected on a liquid surface of the urea and returns.

A liquid level, S1 may be obtained as follows.

S1=untrasonic velocity×T/2,

where T represents a time during which the ultrasonic wave is transmitted, and thereafter, reflected on the liquid level and returns.

Recently, an in-vehicle system, which can inspect the concentration and the quality of the urea in association with CARB and EPA regulations, has been required. When abnormal urea with low quality is used while being injected into the urea tank, a reduction action of NOx in the exhaust gas deteriorates, and as a result, exhaust gas regulations cannot be satisfied and the pump and the injector may abnormally operate due to the foreign substances and corrosion.

As a result, it is stipulated that a system that can inspect the quality of the urea injected into the urea tank is provided in a vehicle. The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure has been made in an effort to solve the above-described problems associated with prior art and to provide a system and a method that can inspect the quality of urea injected into a urea tank by using a simple configuration in a vehicle on which a selective catalytic reduction (SRC) system and a urea supply apparatus are mounted.

According to an embodiment in the present disclosure, a system for inspecting urea quality includes a lower ultrasonic sensor, which is in contact with a urea liquid and installed at a bottom portion of a urea tank inside the urea tank, outputting an ultrasonic wave toward a top portion of the urea tank and receiving the ultrasonic wave reflected on a liquid surface of urea; an upper ultrasonic sensor, which is in contact with the air and installed at the top portion of the urea tank inside the urea tank, outputting the ultrasonic wave toward the bottom portion and receiving the ultrasonic wave reflected on the liquid surface of the urea; and a controller, which is electrically connected with the upper ultrasonic sensor and the lower ultrasonic sensor, configured to calculate a distance from each ultrasonic sensor to the liquid surface of the urea by the ultrasonic wave, which is outputted from both ultrasonic sensors and reflected on the liquid surface of the urea, and configured to determine whether the urea quality is abnormal from the calculated distances.

According to another embodiment in the present disclosure, a method for inspecting urea quality includes outputting, by a lower ultrasonic sensor which is in contact with a urea liquid and installed at a bottom portion of a urea tank, an ultrasonic wave toward a top portion and receiving the ultrasonic wave reflected on a liquid surface of urea; outputting, by an upper ultrasonic sensor which is in contact with the air installed which is in contact with the air of the urea tank inside the urea tank, the ultrasonic wave toward the bottom and receiving the ultrasonic wave reflected on the liquid surface of the urea; and calculating a distance from each ultrasonic sensor to the liquid surface of the urea by the ultrasonic wave which is outputted from both ultrasonic sensors and reflected on the liquid surface of the urea, and determining whether the urea quality is abnormal from the calculated distances.

In the system and the method of urea quality inspection, the quality of the urea injected into the urea tank can be verified by a simple configuration in which the ultrasonic sensor positioned at an opposite side is additionally installed in addition to the ultrasonic sensor for detecting the level of the urea liquid in the urea tank and a problem of an increase in exhaust gas discharge caused due to the abnormal quality of the urea can be prevented and the pump and the injector can be prevented from abnormally operating due to the foreign substances in the urea and the corrosion.

Other aspects and embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram illustrating a urea supplying apparatus in a vehicle adopting an SCR system according to the related art;

FIG. 2 is a perspective view illustrating a urea tank and a pump module of the urea supplying apparatus according to the related art;

FIG. 3 is a diagram for describing a measurement principle of a level sensor detecting the level of urea liquid in the urea tank according to the related art; and

FIG. 4 is a configuration diagram of a urea quality inspection system according to an exemplary embodiment in the present disclosure.

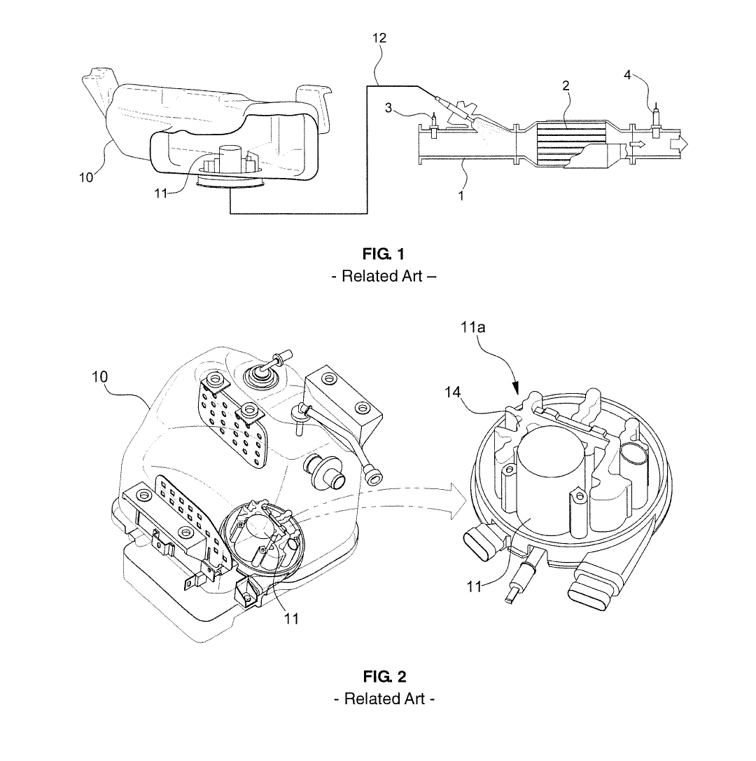

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments in the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

Hereinafter, exemplary embodiments in the present disclosure will be described in detail with reference to the accompanying drawings, so as to be easily implemented by those skilled in the art.

The present disclosure has been made in an effort to provide a system and a method that can inspect the quality of urea injected into a urea tank with a simple configuration in a vehicle on which a selective catalytic reduction (SRC) system and a urea supply apparatus are mounted.

FIG. 4 is a configuration diagram illustrating a urea quality inspection system according to an exemplary embodiment in the present disclosure schematically and illustrates, by an arrow, movement of an ultrasonic wave which is output by each of ultrasonic sensors 21 and 24 and reflected on the surface of urea and returns.

As illustrated in FIG. 4, the ultrasonic sensor 24 is additionally installed on a top portion of a urea tank 10 in addition to a level sensor for detecting the level of urea in the urea tank 10, that is, the existing ultrasonic sensor 21 in the urea tank.

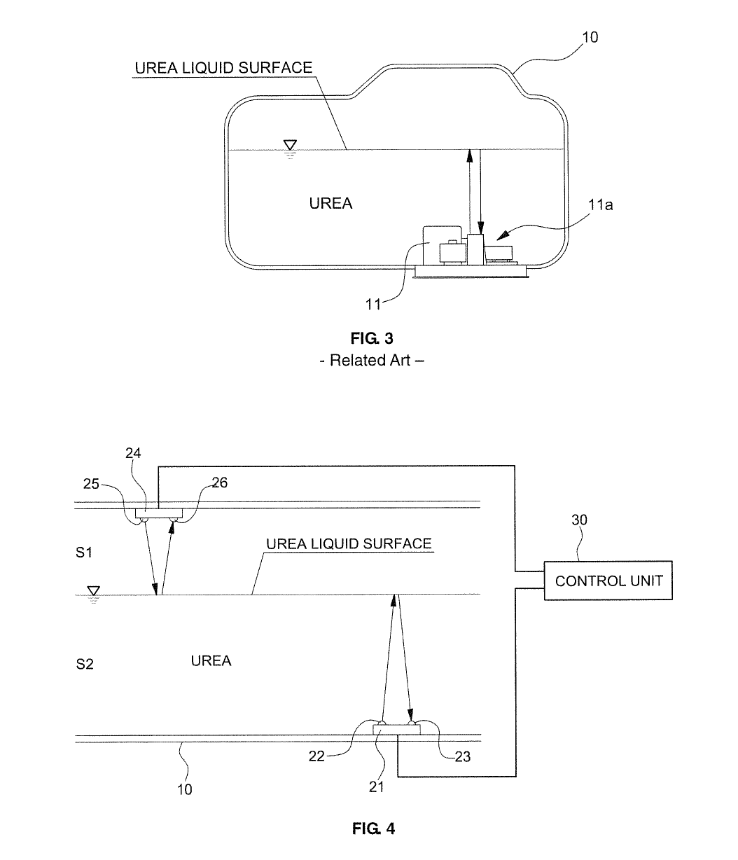

The ultrasonic sensors 21, 24 for detecting the level (liquid level) of the urea liquid in the urea tank 10 may be installed on a bottom portion of the urea tank 10 or on the top portion of the urea tank 10 as illustrated in FIG. 3.

In this case, one ultrasonic sensor is further installed at an opposite side in the urea tank 10 together with one ultrasonic sensor for detecting the level of the urea liquid to use two ultrasonic sensors 21 and 24 capable of inspecting the quality of the urea.

One of the two ultrasonic sensors 21 and 22 may be installed at a height lower than a lowest liquid position of the urea set in the urea tank 10 and the other one may be installed at a height higher than a highest liquid position.

As a result, the lower ultrasonic sensor 21 is in contact with the urea liquid, and the upper ultrasonic sensor 24 is in contact with the air on the top portion of the urea. Here, the lower ultrasonic sensor 21 may be positioned on the bottom portion of the urea tank 10, and the upper ultrasonic sensor 24 may be positioned on the top portion of the urea tank 10.

Both the lower ultrasonic sensor 21 and the upper ultrasonic sensor 24 output an ultrasonic wave toward the surface of the urea and receive the ultrasonic wave which is reflected on the surface of the urea and returns.

The upper ultrasonic sensor 24 includes a transmitter 25 installed to vertically output the ultrasonic wave toward the bottom portion from the top portion of the urea in the urea tank 10. A receiver 26 receives the ultrasonic wave which is reflected on liquid surface of the urea in the urea tank and returns, and in this case, the transmitter 25 and the receiver 26 may be integrally provided.

Similarly, the lower ultrasonic sensor 21 includes a transmitter 22 installed to vertically output the ultrasonic wave toward the top portion from the urea liquid in the urea tank 10. A receiver 23 receives the ultrasonic wave which is reflected on the liquid surface of the urea in the urea tank 10 and returns. Here, the transmitter 22 and the receiver 23 may be integrally provided.

The urea quality inspection system includes a controller 30 electrically connected with each of two ultrasonic sensors 21 and 24. The controller 30 calculates distances S1 and S2 to the urea liquid surface from each ultrasonic sensor by an ultrasonic wave (reflected wave) output by the transmitted units 22 and 25, and thereafter, reflected on the urea liquid surface and received by the receiving units 23 and 26 while controlling operation of two ultrasonic sensors 21 and 24 that output the ultrasonic wave, and determines whether the quality of the urea is abnormal from the calculated distances S1 and S2.

Referring to FIG. 4, a distance S1 (alternatively, a liquid surface height, that is, the level of urea liquid) from a lower sensor position to the urea liquid surface is measured by the lower ultrasonic sensor 21 and a distance S2 from an upper sensor position to the urea liquid surface is measured by the upper ultrasonic sensor 24.

When the ultrasonic wave output from the transmitters 22, 25 of each ultrasonic sensor 21, 24 is reflected on the urea liquid surface and received by the receivers 23, 26, the controller 30 measures a time T1, during which the ultrasonic wave output by the transmitters 22, 25 is received by the receivers 23, 26. The distances S1, S2 from each sensor to the urea liquid surface may be calculated from an equation given below.

S1=V1×T1/2

S2=V2×T2/2,

where S1 represents a distance from the lower ultrasonic sensor 21 to the liquid surface of the urea in the urea tank 10, and S2 represents a distance from the upper ultrasonic sensor 24 to the liquid surface of the urea in the urea tank 10.

V1 represents a velocity of an ultrasonic wave passing through normal urea, V2 represents a velocity of an ultrasonic wave passing through air, and V1 and V2 are values previously input and stored in the controller 30.

T1 represents a time during which the ultrasonic wave transmitted by the lower ultrasonic sensor 21 is reflected on the urea liquid surface and returns, and T2 represents a time during which the ultrasonic wave transmitted by the upper ultrasonic sensor 24 is reflected on the urea liquid surface and returns.

When T1 or T2 is measured by any one of the two ultrasonic sensors 21 and 24, a distance to the urea liquid surface from the bottom of the urea tank 10, that is, the height (urea level) of the urea liquid surface may be measured by the controller 30 like the related art based on the measured T1 or T2.

That is, when the height of each ultrasonic sensor 21, 24 is fixed in the urea tank and the height of each ultrasonic sensor 21, 24 used as a level sensor in the urea tank 10 is stored in the controller 30 as a predetermined value, the level of urea liquid in the urea tank may be measured by using a height between the top portion and the bottom portion of the urea tank 10 and information on a distance to the urea liquid surface from the ultrasonic sensors 21, 24.

When the normal urea is stored in the urea tank 10, a distance between the two ultrasonic sensors 21 and 24 is referred to as H, an equation given below is established.

S2=H−S1 (alternatively, S1=H−S2)

However, since a velocity of an ultrasonic wave output from the ultrasonic sensors 21, 24 and passing through media (air and urea) varies depending on the media, when urea having abnormal quality is filled in the urea tank 10, a relationship of S2≠H−S1 (alternatively, S1≠H−S2) is established.

Accordingly, in the case of S2≠H−S1 (alternatively, S1≠H−S2), the controller 30 may determine that the quality of the urea is abnormal.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

The invention has been described in detail with reference to embodiments thereof. However, it will be appreciated by those skilled in the art that changes may be made in these embodiments without departing from the principles and spirit of the invention, the scope of which is defined in the appended claims and their equivalents.

What is claimed is:

1. A system for inspecting urea quality comprising:
a lower ultrasonic sensor, which is in contact with a urea liquid and installed at a bottom portion of a urea tank inside the urea tank, outputting an ultrasonic wave toward a top portion of the urea tank and receiving the ultrasonic wave reflected on a urea liquid surface;
an upper ultrasonic sensor, which is in contact with the air and installed at the top portion of the urea tank, outputting the ultrasonic wave toward the bottom portion of the urea tank and receiving the ultrasonic wave reflected on the urea liquid surface; and
a controller, which is electrically connected with the upper ultrasonic sensor and the lower ultrasonic sensor, configured to calculate distances from each ultrasonic sensor to the urea liquid surface by the ultrasonic wave, which is outputted from both ultrasonic sensors and reflected on the liquid surface of the urea, and configured to determine whether the urea quality is abnormal using the calculated distances.

2. The system of claim 1, wherein the upper ultrasonic sensor is installed at the top portion inside the urea tank and the lower ultrasonic sensor is installed at the bottom portion inside the urea tank.

3. The system of claim 1, wherein one of the upper ultrasonic sensor and the lower ultrasonic sensor is used as a level sensor, and
wherein the controller configured to calculate a level of the urea liquid in the urea tank from the calculated distances.

4. The system of claim 1, wherein the upper ultrasonic sensor outputs the ultrasonic wave vertically toward the bottom portion and the lower ultrasonic sensor outputs the ultrasonic wave vertically toward the top portion.

5. The system of claim 1, wherein the controller determines that urea is normal when S2=H−S1 or S1=H−S2 is satisfied,
wherein S1, S2 represent distances between the lower ultrasonic sensor and the urea liquid surface and the upper ultrasonic sensor and the urea liquid surface, respectively, and H represents a distance between the upper and lower ultrasonic sensors.

6. The system of claim 1, wherein the controller determines that the quality of the urea is abnormal when S2≠H−S1 or S1≠H−S2 is satisfied based on the calculated distances.

7. The system of claim 1, wherein the distances between the upper ultrasonic sensor and the urea liquid surface and the lower ultrasonic sensor and the urea liquid surface are calculated by S1=V1×T1/2 and S2=V2×T2/2,
wherein T1 represents a time during which the ultrasonic wave transmitted by the lower ultrasonic sensor is reflected on the urea liquid surface and returns, T2 represents a time during which the ultrasonic wave transmitted by the upper ultrasonic sensor is reflected on the urea liquid surface and returns, V1 represents a velocity of the ultrasonic wave in a normal urea, V2 represents a velocity of the ultrasonic wave in the air, and V1 and V2 are values input and stored in the controller in advance.

8. A method for inspecting urea quality comprising:
outputting, by a lower ultrasonic sensor which is in contact with a urea liquid and installed at a bottom portion of a urea tank inside the urea tank, an ultrasonic wave toward a top portion of the urea tank and receiving the ultrasonic wave reflected on a urea liquid surface;
outputting, by an upper ultrasonic sensor which is in contact with the air and installed at the top portion of the urea tank inside the urea tank, the ultrasonic wave toward the bottom portion and receiving the ultrasonic wave reflected on the urea liquid surface; and
calculating a distance from each ultrasonic sensor to the urea liquid surface by the ultrasonic wave which is outputted from both ultrasonic sensors and reflected on the urea liquid surface, and determining whether the urea quality is abnormal from the calculated distance information.

9. The method of claim 8, wherein it is determined that the urea is normal when S2=H−S1 or S1=H−S2 is satisfied,
wherein S1, S2 represent distances between the lower ultrasonic sensor and the urea liquid surface and the upper ultrasonic sensor and the urea liquid surface, respectively, and H represents a distance between the upper and lower ultrasonic sensors.

10. The method of claim 8, wherein it is determined that the urea quality is abnormal when S2≠H−S1 or S1≠H−S2 is satisfied based on the calculated distances.

11. The method of claim 8, wherein the distance between each ultrasonic sensor and the urea liquid surface is calculated by S1=V1×T1/2 and S2=V2×T2/2,
wherein T1 represents a time during which the ultrasonic wave transmitted by the lower ultrasonic sensor is reflected on the urea liquid surface and returns, T2 represents a time during which the ultrasonic wave transmitted by the upper ultrasonic sensor is reflected on the urea liquid surface and returns, V1 represents a velocity of the ultrasonic wave in a normal urea, V2 represents a velocity of the ultrasonic wave in the air, and V1 and V2 are values which are input and stored in the controller in advance.
